(19) United States
(12) Patent Application Publication
(10) Pub. No.: US 2026/0304359 A1
(43) Pub. Date: Oct. 1, 2026

(54) DEVICE AND METHOD FOR PERFORMING SIMULTANEOUS RANGING AND SENSING IN ULTRA WIDEBAND (UWB) SYSTEMS

(71) Applicant: Samsung Electronics Co., Ltd., Suwon-si, Gyeonggi-do (KR)

(72) Inventors: Karthik Srinivasa GOPALAN, Bangalore (IN); Aniruddh Rao KABBINALE, Bangalore (IN); Ankur BANSAL, Bangalore (IN)

(21) Appl. No.: 19/478,653

(22) PCT Filed: Apr. 25, 2024
(86) PCT No.: PCT/KR2024/005626

§ 371 Date: Oct. 24, 2025

(30) Foreign Application Priority Data
Apr. 26, 2023 (IN) 202341030039
Mar. 19, 2024 (IN) 2023 41030039

(51) Int. Cl. H04W 64/00; H04B 1/7163; H04W 56/00

(52) U.S. Cl. CPC H04W 64/00; H04B 1/7163; H04W 56/0015

(57) ABSTRACT

The disclosure relates to a 5G communication system or a 6G communication system for supporting higher data rates beyond a 4G communication system such as long term evolution (LTE). Device and methods for performing simultaneous ranging and sensing in Ultra-Wideband (UWB) systems. Embodiments herein disclose methods and an electronic device (100) to perform simultaneous ranging and sensing in UWB systems. In the embodiment herein, the method can be used to perform simultaneous ranging and sensing using transmission defined for one of ranging or sensing only. In an embodiment herein, the method can be used to perform one or more ranging operations using at least one sensing packet defined for transmission, one or more sensing operations using at least one ranging packet defined for transmission, and one or more sensing operations using at least one MMS ranging packet defined for transmission. Embodiments herein disclose a packet format to perform simultaneous ranging and sensing using single transmission. Embodiments herein disclose a control message field, which can be used for exchanging configuration(s) and schedule(s) for simultaneous ranging and sensing.

### TECHNICAL FIELD

Embodiments disclosed herein relate to Ultra-Wideband (UWB) systems, and more particularly to an electronic device and methods for performing simultaneous ranging and sensing in the UWB systems.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Applications using Ultra-Wideband (UWB) are mostly based on ranging and sensing. Ranging involves measuring the distance between two or more devices based on exchanged messages. Sensing involves presence detection, mapping surroundings using UWB transmissions, and measuring Channel Impulse Response (CIR).

Currently, only one of UWB ranging or UWB sensing can be performed by existing packet formats, transmission schemes, and control message exchanges. There is no existing method to perform simultaneous ranging and sensing using a single transmission. There is no packet format or transmission scheme defined to perform simultaneous ranging and sensing in UWB systems. There is no control message exchange defined to configure and schedule simultaneous ranging and sensing.

To achieve the aforementioned requirements, it is desirable to have a solution to perform simultaneous ranging and sensing in UWB systems.

Hence, there is a need in the art for solutions which will overcome the above mentioned drawback(s), among others.

The principal object of the embodiments herein is to disclose methods and an electronic device to perform simultaneous ranging and sensing in UWB systems.

Another object of the embodiment herein is to disclose methods and an electronic device to perform simultaneous ranging and sensing using a packet format and a transmission scheme defined for one of ranging or sensing only.

Another object of the embodiment herein is to disclose a packet format to perform simultaneous ranging and sensing using a single transmission.

Another object of the embodiment herein is to disclose a control message field, which can be used for exchanging configuration(s) and schedule(s) for performing simultaneous ranging and sensing.

### DISCLOSURE OF INVENTION

### Solution to Problem

Accordingly, the embodiments herein provide methods for performing simultaneous ranging and sensing in Ultra-Wideband (UWB) systems. The method comprises defining, by an electronic device, a control message field, wherein the control message field indicates a packet format. The method further comprises exchanging, by the electronic device, a configuration and a schedule information to one or more other electronic devices based on the defined control message field. The method further comprises performing, by the electronic device, simultaneous one or more ranging operations and one or more sensing operations using the exchanged configuration and the scheduled information.

Accordingly, the embodiments herein provide methods for performing simultaneous ranging and sensing in Ultra-Wideband (UWB) systems. The method comprises one of performing, by an electronic device, one or more ranging operations using at least one sensing packet defined for transmission, and performing, by the electronic device, one or more sensing operations using at least one ranging packet defined for transmission, and performing, by the electronic device, one or more sensing operations using at least one Multi-Millisecond (MMS) ranging packet defined for transmission.

Accordingly, the embodiments herein provide methods for performing simultaneous ranging and sensing in Ultra-Wideband (UWB) systems. The method comprises defining, by an electronic device, a packet format. The method discloses, by the electronic device, performing one or more ranging operations using a Scrambled Time Stamp (STS) and a Synchronisation Preamble (SYNC) fragment of the packet format. The method discloses, by the electronic device, performing one or more sensing operations using a Sensing Preamble (SENS) fragment of the packet format.

Accordingly, the embodiments herein provide an electronic device for performing simultaneous ranging and sensing in Ultra-Wideband (UWB) systems, comprising a processor. The processor is coupled with memory module and configured to define a control message field, wherein the control message field indicates a packet format. The processor is configured to exchange a configuration and a schedule information to one or more other electronic devices based on the defined control message field. The processor is configured to perform simultaneous one or more ranging operations and one or more sensing operations using the exchanged configuration and scheduled information.

Accordingly, the embodiments herein provide an electronic device for performing simultaneous ranging and sensing in Ultra-Wideband (UWB) systems, comprising a processor. The processor is coupled with memory module and configured to perform one of: perform one or more ranging operations using at least one sensing packet defined for transmission, and perform one or more sensing operations using at least one ranging packet defined for transmission, and perform one or more sensing operations using at least one Multi-Millisecond (MMS) ranging packet defined for transmission.

Accordingly, the embodiments herein provide a packet format for performing simultaneous ranging and sensing in Ultra-Wideband (UWB) systems, comprises a Synchronisation Preamble (SYNC) fragment, a Scrambled Time Stamp (STS) and a Sensing Preamble (SENS) fragment. The STS and the SYNC fragment are configured to perform one or more ranging operations, and the SENS fragment is configured to perform one or more sensing operations.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### Advantageous Effects of Invention

Aspects of the disclosure are to address at least the above-mentioned problems and/or disadvantages and to provide at least the advantages described below. Accordingly, an aspect of the disclosure is to provide efficient communication methods in a wireless communication system.

### BRIEF DESCRIPTION OF DRAWINGS

The embodiments disclosed herein are illustrated in the accompanying drawings, throughout which like reference letters indicate corresponding parts in the various figures. The embodiments herein will be better understood from the following description with reference to the drawings, in which:

FIG. 1 depicts an electronic device for performing simultaneous ranging and sensing in Ultra-Wideband (UWB) systems, according to an embodiment as disclosed herein;

FIG. 2 depicts a sensing packet format (as in Institute of Electrical and Electronics Engineers 15.4ab), according to embodiments as disclosed herein;

FIG. 3 depicts a ranging packet format (as in IEEE 15.4z and FiRa), according to embodiments as disclosed herein;

FIG. 4 depicts a packet format for accommodating both ranging and sensing, according to embodiments as disclosed herein; and

FIG. 5 is a flowchart illustrating a method for defining a control message field to exchange a configuration and a schedule information for performing simultaneous ranging and sensing operations, according to embodiments as disclosed herein;

FIG. 6 illustrates a structure of an electronic device according to an embodiment as disclosed herein.

### BEST MODE FOR CARRYING OUT THE INVENTION

Aspects of the disclosure are to address at least the above-mentioned problems and/or disadvantages and to provide at least the advantages described below. Accordingly, an aspect of the disclosure is to provide a terminal and a communication method thereof in a wireless communication system.

### Mode for the Invention

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

The embodiments herein achieve methods and an electronic device to perform simultaneous ranging and sensing in Ultra-Wideband (UWB) systems. Referring now to the drawings, and more particularly to FIGS. 1 through 6, where similar reference characters denote corresponding features consistently throughout the figures, there is at least one embodiment.

Embodiments herein disclose methods and an electronic device to perform simultaneous ranging and sensing in UWB systems using packet format and a transmission scheme defined for one of ranging or sensing only. Embodiments herein disclose a packet format to perform simultaneous ranging and sensing using single transmission. Embodiments herein provide a control message field, which can be used to exchange configuration and schedule for simultaneous ranging and sensing.

Embodiments herein disclose a method to perform ranging and sensing operations using packet format and a transmission scheme related to one of ranging or sensing only. Generally, the pulse shape for sensing is more restricted than a defined ranging pulse. Thus, the sensing pulse can be used for ranging as well if a single transmission is used for both ranging and sensing. Synchronisation Preamble (SYNC) and Sensing Preamble (SENS) fragments are composed of similar sequences and have similar properties. The SYNC fragment can be used for ranging and measuring Channel Impulse Response (CIR) for sensing. It is possible to overload the ranging transmission to perform sensing. It is also possible to overload the sensing transmission to perform ranging. In multi-millisecond (MMS) ranging, the Ranging Preamble Fragments (RSFs) can be used to measure the CIR for sensing. Embodiments herein disclose a method to use sensing transmission to perform ranging. Embodiments herein disclose a method to use ranging transmission to perform sensing. Embodiments herein disclose a method to use Multi-Millisecond (MMS) ranging transmission to perform sensing.

Embodiments herein disclose a method to use sensing transmission to perform ranging. A packet structure (as defined for sensing) can be used for transmission, wherein this transmission enables sensing operations. The SYNC fragment of the sensing packet can be used to perform ranging.

Embodiments herein disclose a method to use ranging transmission to perform sensing. The packet structure as defined for ranging can be used for transmission, wherein this transmission enables secure ranging. The SYNC fragment of the ranging packet can be used for measuring CIR for sensing.

Embodiments herein disclose a method to use MMS ranging transmission to perform sensing. The MMS ranging packet structure can be used for transmission, wherein this transmission enables MMS ranging. The RSFs of the MMS ranging transmission can be used for measuring CIR for sensing.

Embodiments herein disclose a packet format to perform simultaneous ranging and sensing using a single transmission. A typical ranging packet comprises a synchronisation preamble, a Scrambled Time Stamp (STS) and an optional data payload. A typical sensing packet comprises a synchronisation preamble, a sensing preamble fragment, and an optional data payload. The disclosed packet format comprises the SYNC fragment, the STS and the SENS fragment. The packet format can enable both ranging and sensing. Sensing can be performed using the SENS fragment of the transmission. Ranging can be performed using the SYNC and the STS part of the transmission.

Embodiments herein disclose a control message field, wherein the control message field can be used to exchange configuration and schedule information for simultaneous sensing and ranging activity. Embodiments herein define a control field (hereinafter referred to as a “Integrated Sensing and Ranging” (ISAR) control field) as part of the control message exchange. This field indicates the packet format used for simultaneous ranging activity and other configurations. Embodiments herein define a flag, “ISAR active,” as part of schedule information to indicate that ISAR has been performed. Embodiments herein use the terms ‘ISAR” or ‘Non-sensing” Transmission (TX) CIR Report Parameters field’ as in Institute of Electrical and Electronics Engineers (IEEE) interchangeably to refer to ‘Integrated Sensing and Ranging’, which can perform simultaneous sensing and ranging operations in UWB systems.

FIG. 1 depicts an electronic device 100 to perform simultaneous ranging and sensing in UWB systems. The electronic device 100 comprises a processor 102, a communication module 104, and a memory module 106. The electronic device 100 can be a real-world device, wherein the electronic device 100 can be a device capable of using the wireless communication network. Examples of the electronic device 100 can be, but not limited to, a desktop, a laptop, a smart phone, a personal digital assistant, a wearable device, a kitchen appliance, a smart appliance, an Internet of Things (IoT) device, and so on. The device 100 can be interchangeably referred to herein as a source device, a first device, and so on. In an embodiment herein, the processor 102 can prepare at least one Information Element (IE) for sending a message by the electronic device 100 to one or more second electronic devices (also referred to herein as a target device).

In an embodiment herein, the processor 102 can perform simultaneous ranging and sensing in UWB systems using transmission defined for one of ranging or sensing only. The processor 102 can perform one or more ranging operations using at least one sensing packet defined for transmission. The SYNC fragment of the sensing packet can be used to perform ranging.

The processor 102 can perform one or more sensing operations using at least one ranging packet defined for transmission. The SYNC fragment of the ranging packet can be used for measuring CIR for sensing.

The processor 102 can perform one or more sensing operations using at least one MMS ranging packet defined for transmission. The RSFs of the MMS ranging transmission can be used for measuring CIR for sensing.

The processor 102 can define a control message field to exchange a configuration and a schedule information to one or more other electronic devices. The control message field indicates a packet format used for performing simultaneous one or more ranging operations and one or more sensing operations.

In an embodiment herein, the processor 102 may comprise one or more microprocessors, circuits, and other hardware configured for processing. The processor 102 can be configured to execute instructions stored in the memory module 106.

The processor 102 can be at least one of a single processor, a plurality of processors, multiple homogeneous or heterogeneous cores, multiple Central Processing Units (CPUs) of different kinds, microcontrollers, special media, and other accelerators. The processor 110 may be an Application Processor (AP), a graphics-only processing unit such as a Graphics Processing Unit (GPU), a Visual Processing Unit (VPU), and/or an Artificial Intelligence (AI)-dedicated processor such as a Neural Processing Unit (NPU).

In an embodiment herein, the communication module 104 is configured to enable communication between the electronic device 100 and one or more second electronic devices. The server may be configured or programmed to execute instructions of the electronic device 100. The communication module 104 through which the electronic device 100 and the server communicate may be in the form of either a wireless network or a combination thereof.

In an embodiment herein, the memory module 106 may comprise one or more volatile and non-volatile memory components which are capable of storing data and instructions to be executed. Examples of the memory module 106 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory module 106 may also include one or more computer-readable storage media. Examples of non-volatile storage elements may include magnetic hard discs, optical discs, floppy discs, flash memories, or forms of electrically programmable memories (EPROM) or electrically erasable and programmable (EEPROM) memories. In addition, the memory module 106 may, in some examples, be considered a non-transitory storage medium. The term “non-transitory” may indicate that the storage medium is not embodied in a carrier wave or a propagated signal. However, the term “non-transitory” should not be interpreted to mean that the memory module 106 is non-movable. In certain examples, a non-transitory storage medium may store data that can, over time, change (e.g., in Random Access Memory (RAM) or cache).

Although FIG. 1 shows various hardware components of the electronic device 100, but it is to be understood that other embodiments are not limited thereon. In other embodiments, the electronic device 100 may include less or more number of components. Further, the labels or names of the components are used only for illustrative purpose and does not limit the scope of the invention. One or more components can be combined together to perform same or substantially similar function in the electronic device 100.

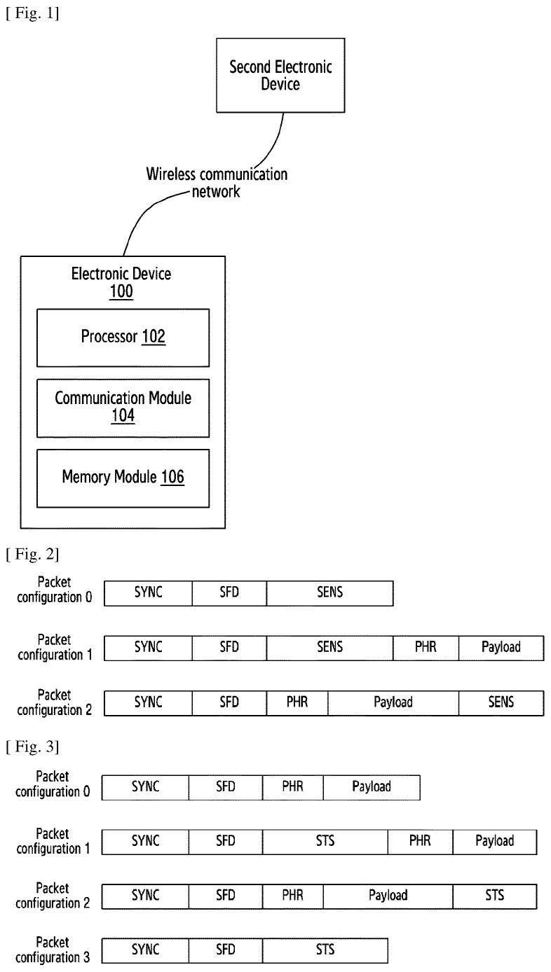

In Institute of Electrical and Electronics Engineers (IEEE) 15.4ab, packet formats are defined for performing sensing. FIG. 2 depicts the sensing packet format (as in IEEE 15.4ab). The sensing packet format is [SYNC+SFD]+[SENS]+optional [PHR+Payload]. The SYNC preambles enable synchronization. The Synchronization Fragment Delimiter (SFD) separates the SYNC fragment from other fragments. The SENS fragment enables reporting CIR for sensing. The [Physical Layer Header (PHR)+Payload] of the sensing packet format is an optional field. The PHR is a header, and the Payload gives information about the data payload. The header gives information about the data before sending the payload, such as types of data, length of the data, data rate, and so on. Packet configuration 0, Packet configuration 1, and Packet configuration 2 are different embodiments of the sensing packet format.

Embodiments herein use UWB sensing transmission to perform UWB ranging. Embodiments herein use the UWB sensing packet format defined in IEEE 15.4ab for transmission. Embodiments herein use SYNC preambles for ranging measurements.

IEEE 15.4z and FiRa define packet formats for secure UWB ranging. FIG. 3 depicts the ranging packet format (as in IEEE 15.4z and FiRa). Secure ranging has a packet format of [SYNC+SFD]+optional [STS]+optional [PHR+Payload]. The STS brings in physical layer security. The SYNC preambles enable synchronization and also enable ranging. The SFD separates SYNC fragments from other fragments. The STS and [PHR+Payload] of the ranging packet format are optional fields. Packet configuration 0, Packet configuration 1, Packet configuration 2, and Packet configuration 3 are the different embodiments of the ranging packet format.

Embodiments herein use UWB ranging transmission to perform UWB sensing. If the STS is present in the transmission, this will enable secure ranging. The CIR measurements for sensing can be made using the SYNC preamble sequence in the transmission. This transmission is also backward compatible with 15.4 z.

IEEE 15.4ab defines packet format and ranging sequence for secure MMS UWB ranging. MMS ranging comprises ranging preamble fragments and ranging integrity fragments, wherein each fragment is transmitted at an average of a millisecond apart. The ranging preamble fragments enable synchronization and also enable ranging.

Embodiments herein disclose using UWB ranging transmission to perform UWB sensing. The CIR measurements for sensing can be made using the ranging preamble sequence fragments in the transmission.

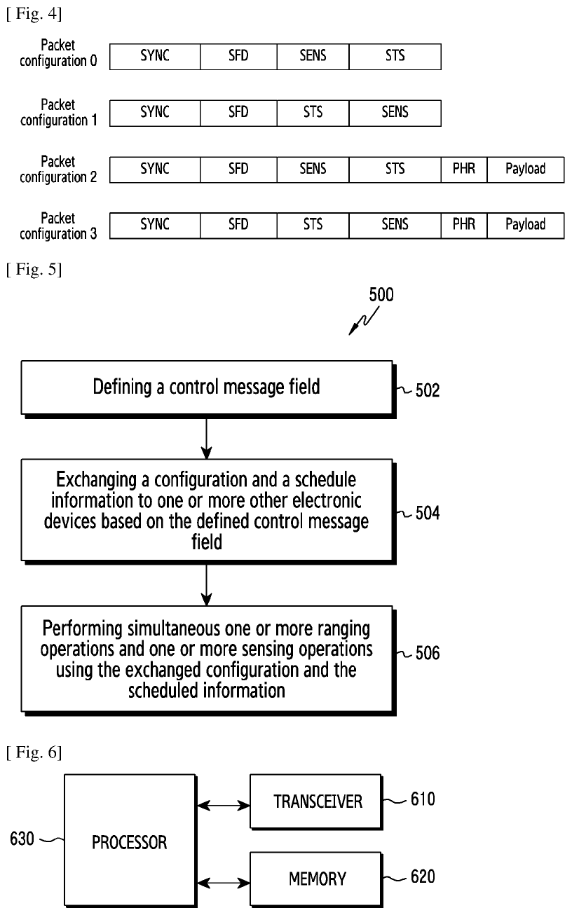

FIG. 4 depicts a packet format for accommodating both ranging and sensing. Embodiments herein disclose that the packet comprises [SYNC+SFD]+[SENS]+[STS]+optional [PHR+PHY Payload] in any combination. Sensing can be performed using the SENS fragment of the transmission. Ranging can be performed using the SYNC and the STS part of the transmission. The SFD separates SYNC fragments from other fragments. The [PHR+PHY Payload] of the packet format is an optional field. Packet configuration 0, Packet configuration 1, Packet configuration 2, and Packet configuration 3 are the different embodiments of the proposed packet format.

Embodiments herein disclose the control field, which can be used for control and schedule information for performing simultaneous ranging and sensing. Embodiments herein define the ISAR control field as part of the control message exchange. This field indicates the packet format used for simultaneous ranging activity and other configurations.

Table 1 shows an example application control IE, which is shared as part of control message exchange. The application control IE comprises one specific field (hereinafter referred to as the ISAR control field). In an embodiment herein, (Bits 0−X) indicates the rest of the application control IE, and (Bits X+1−Y) indicate the ISAR control field as shown in Table 1.

TABLE 1

| Bits 0-X | Bits X + 1 − Y |
|---|---|
| Rest of Application control IE | ISAR control field |

Table 2 shows an example ISAR control field. In the embodiment herein, as a part of a control message exchange, the ISAR control field contains an ISAR packet format usage and other configuration parameters. In the embodiment herein, the ISAR packet format usage is a 2 bit field, where value 0 indicates that a packet format defined in sensing control has been used, value 1 indicates that a packet format defined for ranging in IEEE 15.4z has been used, value 2 indicates that a packet format defined for MMS ranging has been used, and value 3 indicates that the proposed packet format has been used, as shown in Table 2.

TABLE 2

| Bits 0-3 | 4-X |
|---|---|
| ISAR Packet format usage | Rest of ISAR control field |

In another embodiment, the “ISAR active” flag is defined as part of schedule information to indicate that ISAR (both ranging and sensing operations) has been performed.

Embodiments herein disclose a method for performing simultaneous ranging and sensing in UWB systems. The method discloses performing one or more ranging operations using at least one sensing packet defined for transmission. The one or more ranging operations are performed using the SYNC fragment of the at least one sensing packet defined for transmission. The method discloses performing one or more sensing operations using at least one ranging packet defined for transmission. The one or more sensing operations are performed using the SYNC fragment of the at least one ranging packet defined for transmission, which comprises measuring the CIR for sensing. The method discloses performing one or more sensing operations using at least one Multi-Millisecond (MMS) ranging packet defined for transmission. The one or more sensing operations using the ranging preamble sequence fragment of the at least one MMS ranging packet comprise measuring the CIR for sensing.

Embodiments herein disclose a method for performing simultaneous ranging and sensing in UWB systems by defining a packet format. The packet format comprises a SYNC fragment, a STS, and a SENS fragment. The STS and the SYNC fragment are configured to perform one or more ranging operations. The SENS fragment is configured to perform one or more sensing operations.

FIG. 5 is a flowchart illustrating a method for defining a control message field to exchange a configuration and a schedule information for performing one or more ranging operations and one or more sensing operations simultaneously. The operations (502-506) are handled by the electronic device 100. At step 502, the method discloses, defining a control message field. At step 504, the method discloses exchanging a configuration and a schedule information to one or more other electronic devices based on the defined control message field. At step 506, the method discloses performing simultaneous one or more ranging operations and one or more sensing operations using the exchanged configuration and the scheduled information. The control message field comprises at least one of an Integrated Sensing and Ranging (ISAR) control field and a flag ISAR. The ISAR control field indicates a packet format used for performing simultaneous one or more ranging operations, and one or more sensing operations and an active ISAR flag indicates that the ISAR is performed.

The various actions, acts, blocks, steps, or the like in the method and the flow diagram 500 may be performed in the order presented, in a different order, or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements. The elements can be at least one of a hardware device, or a combination of hardware device and software module.

The embodiments disclosed herein describe methods and the electronic device 100 to perform simultaneous ranging and sensing in UWB systems. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The electronic device 100 may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

FIG. 6 illustrates a structure of an electronic device according to embodiments of the disclosure.

As shown in FIG. 6, the electronic device according to an embodiment may include a transceiver 610, a memory 620, and a processor 630. The transceiver 610, the memory 620, and the processor 630 of the electronic device may operate according to a communication method of the electronic device described above. However, the components of the electronic device are not limited thereto. For example, the electronic device may include more or fewer components than those described above. In addition, the processor 630, the transceiver 610, and the memory 620 may be implemented as a single chip. Also, the processor 630 may include at least one processor. Furthermore, the electronic device of FIG. 6 corresponds to the electronic device of the FIG. 1. The electronic device may correspond to a user equipment (UE), a base station (BS), or a network function entity in a network.

The transceiver 610 collectively refers to an electronic device receiver and an electronic device transmitter, and may transmit/receive a signal to/from a terminal (UE) or a network entity. The signal transmitted or received to or from the terminal or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the electronic device. Also, the memory 620 may store control information or data included in a signal obtained by the electronic device. The memory 620 may be a storage medium, such as read-only memory (ROM), random access memory (RAM), a hard disk, a CD-ROM, and a DVD, or a combination of storage media.

The processor 630 may control a series of processes such that the electronic device operates as described above. For example, the transceiver 610 may receive a data signal including a control signal transmitted by the terminal, and the processor 630 may determine a result of receiving the control signal and the data signal transmitted by the terminal.

The processor disclosed herein may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

1. A method performed by an electronic device (100) in Ultra-Wideband (UWB) systems, the method comprising:
defining a control message field, wherein the control message field indicates a packet format;
exchanging a configuration and a schedule information to one or more other electronic devices based on the defined control message field; and
performing simultaneous one or more ranging operations and one or more sensing operations using the exchanged configuration and the scheduled information.

2. The method of claim 1, the method further comprising at least one of:
performing one or more ranging operations using at least one sensing packet defined for transmission;
performing one or more sensing operations using at least one ranging packet defined for transmission; and
performing one or more sensing operations using at least one Multi-Millisecond (MMS) ranging packet defined for transmission.

3. The method of claim 2, wherein the performing the one or more sensing operations using the at least one ranging packet comprises measuring a Channel Impulse Response (CIR) for sensing.

4. The method of claim 2, wherein the performing the one or more sensing operations using the at least one MMS ranging packet comprises measuring the Channel Impulse Response (CIR) for sensing.

5. The method of claim 1, the method further comprising:
defining a packet format, wherein the packet format comprises a Scrambled Time Stamp (STS), a Synchronisation Preamble (SYNC);
performing one or more ranging operations using the Scrambled Time Stamp (STS) and the Synchronisation Preamble (SYNC) fragment of the packet format.

6. The method of claim 5, wherein the packet format further comprises a Sensing Preamble (SENS) fragment, and
the method further comprises performing one or more sensing operations using the Sensing Preamble (SENS) fragment of the packet format.

7. The method of claim 5, wherein the packet format further comprises an optional data payload for performing the one or more ranging operations and the one or more sensing operations.

8. An electronic device (100), comprising:
a processor (102), and
a memory module (106);
wherein the processor (102) is coupled with the memory module (106), and configured to:
define a control message field, wherein the control message field indicates a packet format;
exchange a configuration and a schedule information to one or more other electronic devices based on the defined control message field; and
perform simultaneous one or more ranging operations and one or more sensing operations using the exchanged configuration and the scheduled information.

9. The electronic device (100) of claim 8, wherein the processor further configured to perform at least one of:
one or more ranging operations using at least one sensing packet defined for transmission;
one or more sensing operations using at least one ranging packet defined for transmission; and
one or more sensing operations using at least one Multi-Millisecond (MMS) ranging packet defined for transmission.

10. The electronic device (100) of claim 9, wherein the processor (102) is configured to perform the one or more sensing operations using the at least one ranging packet, and
wherein the processor is further configured to measure a Channel Impulse Response (CIR) for the one or more sensing operations.

11. The electronic device (100) of claim 9, wherein the processor (102) is configured to perform the one or more sensing operations using the at least one MMS ranging packet, and
wherein the processor is further configured to measure the Channel Impulse Response (CIR) for the one or more sensing operations.

12. The electronic device (100) of claim 8, wherein a packet format for simultaneous ranging and sensing comprises a Synchronisation Preamble (SYNC) fragment, a Scrambled Time Stamp (STS), and a Sensing Preamble (SENS) fragment.

13. The electronic device (100) of claim 12, wherein the processor is configured to perform one or more ranging operation based on the STS and the SYNC fragment.

14. The electronic device (100) of claim 12, wherein the processor is configured to perform one or more ranging operation based on the SENS fragment.

15. The electronic device (100) of claim 12, wherein the packet format comprises an optional data payload for the one or more ranging operations and the one or more sensing operations.
